(19) United States
(12) Patent Application Publication
(10) Pub. No.: US 2014/0123419 A1
(43) Pub. Date: May 8, 2014

(54) Versatile Cleansing Wipe Products

(71) Applicant: Kevin K. Kirk, Irving, TX (US)

(72) Inventor: Kevin K. Kirk, Irving, TX (US)

(21) Appl. No.: 13/668,957

(22) Filed: Nov. 5, 2012

(51) Int. Cl. A47L 13/19; B32B 43/00; A47L 13/17

(52) U.S. Cl. 15/104.94; 15/227; 29/592

(57) ABSTRACT

The present invention defines embodiments of a wipe product (100), having a plurality of layers (104). A first surface (102) of the layers may be produced or adapted for moistening with a desired liquid. A second surface (106) of the layers may be adapted to dry a desired area. The wipe product has an opening (110) in the plurality of layers, adapted to receive a portion of a user's hand.

### TECHNICAL FIELD OF THE INVENTION

The present invention relates generally to the field of general-purpose and personal hygiene cleansing products and, more particularly, to structures and methods for producing versatile cleansing wipes, and wipe products, for use in a variety of industrial, medical, home, human and/or animal applications.

### BACKGROUND OF THE INVENTION

A wide variety of pre-moistened wipe products are available for hygienically cleansing the genital and anal areas of a baby or adult, and there are also a number of wipe-style products for hygienic and general cleansing of animals. Similarly, there are numerous pre-moistened cleansing wipes intended for home, automotive, medical and/or industrial uses. While the intended uses and users may vary, most conventional products share a number of similar characteristics, and face a number of issues.

Typically, conventional cleansing wipe products have a rectangular or square for m factor, and are usually slightly larger in size than an average human hand. Such products are commonly formed of a soft, thin material that may be either single-ply or multi-ply. Such products are typically pre-moistened with some combination of cleansing and conditioning solutions. In some cases, the intended use is to not only clean but also soften or soothe the surface area being wiped (e.g., personal hygiene wipes for hum an use). In other cases, the intended use may be to clean and condition the surface are a being wiped (e.g., furniture or automotive wipes). And in still other cases, the intended use may be exclusively cleaning or exclusively conditioning the surface area being wiped (e.g., disinfectant medical wipes or bleach-based household cleaning wipes). Some conventional wipes are formed from a continuous run of material, having perforations to assist in separating one wipe from another, which is conformally folded or rolled for dispensing. Other conventional wipes are individually formed and separated from one another, and usually conformally folded for dispensing. Typically, numerous wipes are packaged together for dispensing in some type of sealable container, to preserve the pre-moistening and keep them from drying out.

Regardless of their intended use, form factor, composition or packaging, conventional wipe products typically face a number of similar issues and limitations. In some instances, consumers may find it difficult to dispense only one wipe at a time. As a result, product is wasted and can be cumbersome and messy to dispose of. Where a single wipe product is dispensed, overly thin material can result in tearing and/or break-through as the wipe is used, exposing a consumer to undesirable contact or contamination. As a result, the consumer may decide to fold the wipe over one or more times, reducing the effective cleansing surface of the wipe and further exposing the consumer's hand to undesirable contact or contamination. If the cleansing wipe products are opened and not used relatively promptly, imperfections in the wipe packaging can lead to the wipes drying out and becoming unusable.

The most common limitation of conventional cleansing wipe products, however, is due to the manner in which they are pre-moistened, packaged and dispensed. In some cases, a consumer may find that the wipe contains an insufficient amount of cleansing or conditioning solution, requiring use of additional wipes or additional cleansing product to produce the desired effect. Very often, however, a consumer using a conventional cleansing wipe will find that, after cleansing, the surface area just cleansed is left undesirably damp or wet. If the consumer wants the surface left dry, they must then obtain and use some other product (e.g., dry cloth, paper towel, toilet paper) to effectively absorb all liquid and/or contaminants from the surface to complete the cleansing process. In all such instances, the consumer does not have the ability to control or adjust the amount of pre-moistened fluid in a single conventional wipe.

As a result, there is a need for a versatile cleansing wipe system that provides similar advantages and conveniences of conventional cleansing wipe products, while overcoming numerous limitations and disadvantages of those conventional products.

### SUMMARY OF THE INVENTION

The present invention provides a versatile cleansing wipe system in a convenient, easy and economical manner. The system of the present invention provides a single wipe product, that may fully or partially envelope a consumer's hand, having both a cleansing surface and a drying (or absorbing) surface. The system of the present invention provides a single wipe product that may be produced with the cleansing surface pre-moistened, or un-moistened in order to allow a consumer to select the type and amount of cleansing product to be used, or alternatively, to use the wipe product exclusively for drying/absorbing. The system of the present invention provides a single wipe product that may be produced in a wide variety of sizes and form-factors, and packaged and dispensed in a number of ways. The system of the present invention provides a single wipe product that may be produced utilizing already-existing materials and manufacturing equipment, or may be produced using evolving production innovations and technology.

More specifically, the system of the present invention provides various structures and methods for a wipe product having a plurality of layers. The wipe product may have a first surface of the layers adapted for moistening with a desired liquid—cleansing or conditioning fluid(s), for example. A second surface of the layers may be adapted to dry a desired area, such as after treatment with the first surface and liquid, or to absorb liquid and/or contaminant material from the desired area. The wipe also has an opening in the plurality of layers, adapted to receive a portion of a user's hand—whether that is one or two fingers, the entire hand, or the entire hand and wrist area.

Among its various embodiments, the system of the present invention provides structures and methods for a personal hygiene wipe product. This wipe product has a first layer, with a surface adapted for moistening with a desired liquid. A second layer has a surface adapted to dry, or absorb material from, a desired area (hereinafter collectively referred to as “dry”, “drying” or “dried”). The wipe product has a third layer, interposed between the first and second layers. This layer is adapted to prevent the desired liquid from dampening the surface of the second layer. The wipe product also has an opening adapted to receive a portion of a user's hand.

The system of the present invention provides various methods of producing cleansing wipe products. Those methods provide a plurality of layers, having a first surface that may be adapted for moistening with a desired liquid and a second surface that may be adapted to dry a desired area. In alternative embodiments, the second surface may be adapted for moistening with a second desired liquid. In other alternative embodiments, the first and second surfaces may both be adapted to dry a desired area, or otherwise apply a dry material to the area. The methods further form an opening in the plurality of layers, wherein the opening is adapted to receive a portion of a user's hand.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is an illustration depicting one embodiment of a wipe product according to the present invention;

FIGS. 2a-2b are illustrations depicting embodiments of a wipe product according to the present invention;

FIGS. 3a-3d are illustrations depicting various embodiments of wipe products according to the present invention;

FIGS. 4a-4e are illustrations depicting an embodiment of the use of a wipe product according to the present invention;

FIG. 5 is an illustration depicting an embodiment of producing a wipe product according to the present invention; and

FIGS. 6a-6c are illustrations depicting certain aspects of various embodiments of wipe products according to the present invention; and

FIGS. 7a-7d are illustrations depicting certain embodiments of wipe products and their use according to the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The invention is primarily described and illustrated hereinafter in conjunction with various embodiments of cleansing wipes that a consumer may use by hand. The specific embodiments discussed herein are merely illustrative of specific ways to make and use the invention and do not limit the scope of the invention.

A cleansing wipe system of the present invention provides a single wipe product, that may fully or partially envelope a consumer's hand. The wipe product, or wipe, may have both a cleansing surface and a drying surface, or may have a plurality of either. The single wipe product of the present invention may be produced with the cleansing surface pre-moistened or un-moistened. In embodiments where the wipe product of the present invention is produced with the cleansing surface un-moistened, it may be packaged or provided in conjunction with one or more solutions or solvents that a consumer may select to apply to the cleansing surface of the wipe. The wipes of the present invention may be provided and/or packaged in a manner that is specific to a particular end-use—such as baby wipes or personal hygiene wipes, for example—or may be provided and/or packaged in a general-purpose manner.

The wipes of the present invention may be provided with a number of features that facilitate a particular end-use or disposal. Various handling and closure features may be provided in accordance herewith. The wipes of the present invention may be produced or provided in a variety of sizes and shapes—ranging from finger-cot form factors to medical cleansing gauntlets—and may comprise varying materials within a single wipe.

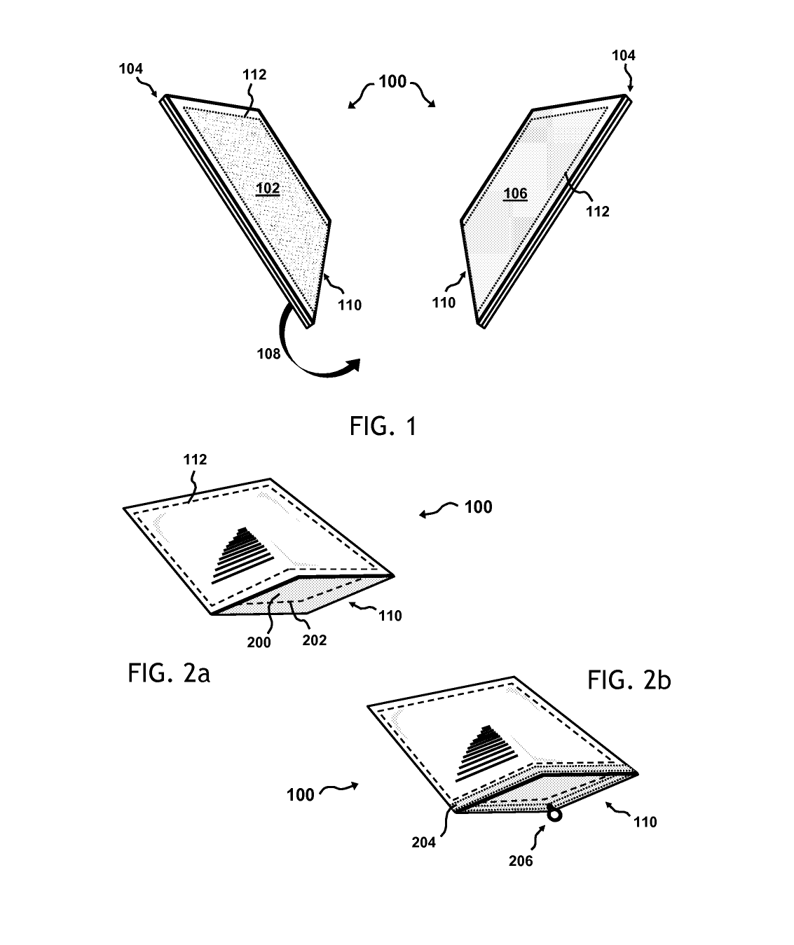

Referring now to FIG. 1, the present invention is described in greater detail in reference to one general embodiment of a wipe product 100 according to the present invention. A first surface 102 of the wipe 100 comprises material suitable for moistening with a cleansing or conditioning solution or solvent. The solution or solvent may be applied to surface 102—referred to hereinafter as the “wet surface”—during the manufacturing or packaging of wipe 100, or may be applied as desired by a consumer when ready for use. Wipe 100 comprises a plurality of layers or p lies 104 that provide for physical separation of surface 102 from an opposing drying surface 106—referred to herein after as the “drying surface.” Drying surface 106 may comprise the same material as surface 102, or a different material having better “drying characteristics” such as absorbency. In some embodiments, surface 106 may further comprise some powder or other dry compound intended to be applied to the surface while being dried or wiped down. During use, a consumer may alternate use between surfaces 102 and 106 by simply turning the wipe over 108.

Wipe 100 comprises at least one opening 110 between layers 104 that facilitates use of the wipe by allowing some portion of a consumer's hand within the wipe 100. Layers 104 may be bound or joined together by any suitable coupling, such as perimeter seam 112. Seam 112 may be formed using an adhesive, heat-treating, pressure treating, or some suitable combination thereof. Other embodiments of joining layers 104 together are hereby comprehended, as such may vary widely depending upon manufacturing systems and materials.

Referring now to FIGS. 2a and 2b, features and embodiments of wipe 100 are illustrated with further specificity and detail. In FIG. 2a, opening 110 is shown in a substantially open position, facilitating placement of wipe 100 over or around some portion of a consumer's hand, between layers 104 as described above. Depending upon the composition and arrangement of layers 104, wipe 100 may comprise a lining 200 specifically disposed within opening 110 to receive and/or cover a consumer's hand or fingers. Lining 200 may be formed simply by selection of desirable internal layers and seam 112. In other embodiments, lining 200 may comprise a sprayed-in or coated treatment of opening 110, or a separate pouch inserted within opening 110 either during use, or during manufacture, of wipe 100. Lining 200 may be provided of the same material or fabric as outer layers of layers 104, or may be provided using a material different therefrom.

As seen in FIG. 2a, seam 112 may—depending upon the materials and processes used, and upon the desired configuration of wipe 100—be formed along the entire perimeter of wipe 100 or, as in FIG. 1, along the perimeter of wipe 100 excluding the portion adjacent to opening 110. An inner seam 202 may be provided to secure lining 200 in place. Seam 202 may be formed simply as part of seam 112, or provided as a separate seam.

In FIG. 2b, an embodiment of wipe 100 comprises a cuff or margin portion 204 around opening 110. Portion 204 may be formed or provided to facilitate use of wipe 100, as described hereinafter. In other embodiments, portion 204 may be provided for aesthetic purposes. In still other embodiments, portion 204 may be formed and provided to facilitate removal and disposal of wipe 100, as described hereinafter.

Portion 204 may further comprise a closure feature 206. In the embodiment depicted, feature 206 may be formed of wire, string, thread, or some other textile strip, slidably disposed along and within portion 204 and adapted to gather together or close opening 110 when pulled or actuated. In other embodiments, feature 206 may comprise an exposable adhesive strip, a hook-and-loop material patch or strip, a zip-seal or snap-seal section, or any other material or form that suitably fastens or secures the closure of opening 110 as described herein. Feature 206 may be formed within portion 204, or within the layers 104, or simply disposed or affixed along the inner perimeter of opening 110. In other embodiments, feature 206 may be a separate closure mechanism—such as a tape strip or zip-tie structure—that is deployed by a consumer after closure of opening 110.

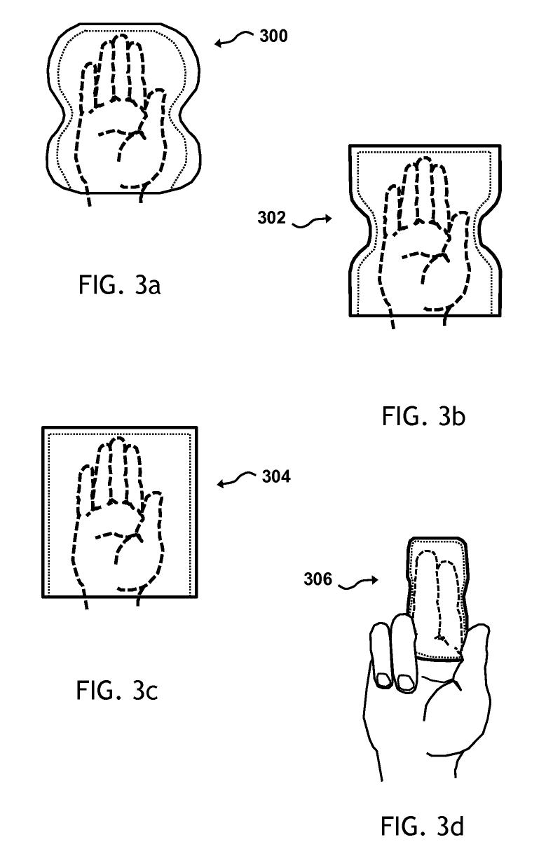

Referring now to FIGS. 3a-3d, various embodiments of wipe 100 are depicted in a variety of shapes and form factors. FIG. 3a depicts an embodiment of the present invention wherein a wipe product 300 is provided having a size suitable to enclose a consumer's hand within. Wipe 300 is provided having a rounded, contoured shape similar to a figure “8”. FIG. 3b depicts an embodiment of the present invention wherein wipe product 302 has a size suitable to enclose a consumer's hand within, and is provided in an hourglass shape. FIG. 3c depicts an embodiment of the present invention wherein wipe product 304 has a size suitable to enclose a consumer's hand within, and is provided in a rectangular or square shape. FIG. 3d depicts an embodiment of the present invention wherein wipe product 306 has a size suitable to enclose one or more of a consumer's fingers within. Wipe 306 is provided having an irregularly contoured shape. In various alternative embodiments, a wipe product may be provided having sufficient size and shape to accommodate not only a user's hand, but also to cover some portion of the user's wrist and/or forearm. The wipe product of the present invention may therefore be provided with any suitable shape and size to facilitate the intended use.

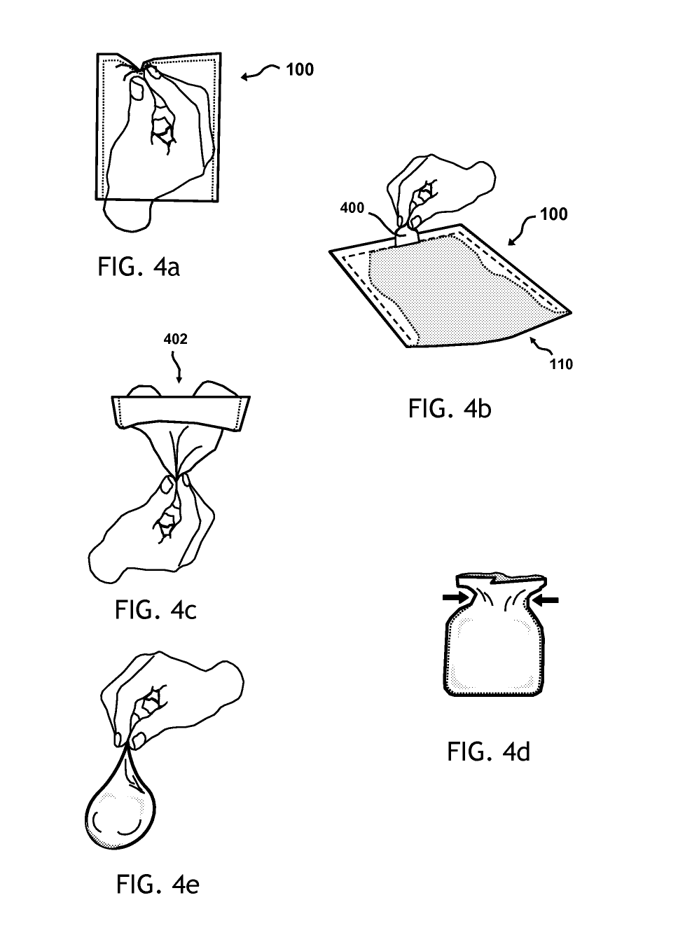

The use of a wipe product according to the present invention is described in greater detail with reference now to FIGS. 4a-4e. A consumer selects a wipe 100, and places his/her hand or fingers within the opening therein. In embodiments where the wet surface is not pre-moistened, the consumer applies a desired solution or solvent in a desired amount to surface 102. Once the wet surface is either pre-moistened or consumer-moistened, the consumer uses the wet surface of wipe 100 to cleanse or condition a targeted surface area. After using the wet surface of wipe 100, the consumer changes the position of wipe 100 to now use the drying surface thereof. In some embodiments, the consumer may remove the wipe and turn or rotate it before putting it back on to use the drying surface. In other embodiments, the consumer may simply turn their hand or fingers within the wipe until the drying surface is in a desired position. In still other embodiments, as described hereinafter, the consumer may invert the inner and outer surfaces of the wipe to expose the drying surface.

In some end uses, the consumer may at this point simply remove the wipe from their hand or fingers and dispose of it. However, in some other end-uses—such as baby wipes—it may be desirable to close up the wipe product before disposal, in a manner that reduces or obviates exposure of contaminants on the wet and/or dry surfaces. Therefore, certain embodiments of the present invention are provided such that the consumer may close up or otherwise invert the inn er and outer surfaces of the soiled wipe product, as illustratively depicted in FIGS. 4a-4e. In FIG. 4a, once a consumer is done using wipe 100, they begin a process of inverting the interior and exterior portions of the wipe by grasping or pinching an inner portion of wipe 100, opposite opening 110. Certain embodiments of wipe 100 may be provided with an inner pull portion 400 to facilitate that grasping or pinching. Portion 400 may be formed as a simple textile tab, as depicted in FIG. 4b, disposed along the inner seam portion of wipe 100 opposite opening 110. In other embodiments, portion 400 may be provided as a string or thread, in a loop or freely hanging. Any suitable material in a configuration that facilitates grasping or pinching by the consumer is comprehended by the present invention.

Referring now to FIG. 4c, the consumer pulls the interior portion of wipe 100 through opening 110, inverting the wipe and enclosing the wet and drying surfaces within a now-formed upwardly-facing closure pouch 402. As depicted in FIG. 4d, the consumer may now crumple, collapse, pinch, twist or otherwise close pouch 402. In embodiments where wipe 100 comprises a closure feature, the consumer may actuate or deploy that feature to securely seal pouch 402. Once the used wipe 100 is inverted and closed, it may be disposed of in a sanitary manner, as depicted in FIG. 4e. Depending upon the materials used in wipe 100, disposal may comprise depositing the closed wipe in a trash receptacle or sanitary container, or flushing the closed wipe in a toilet.

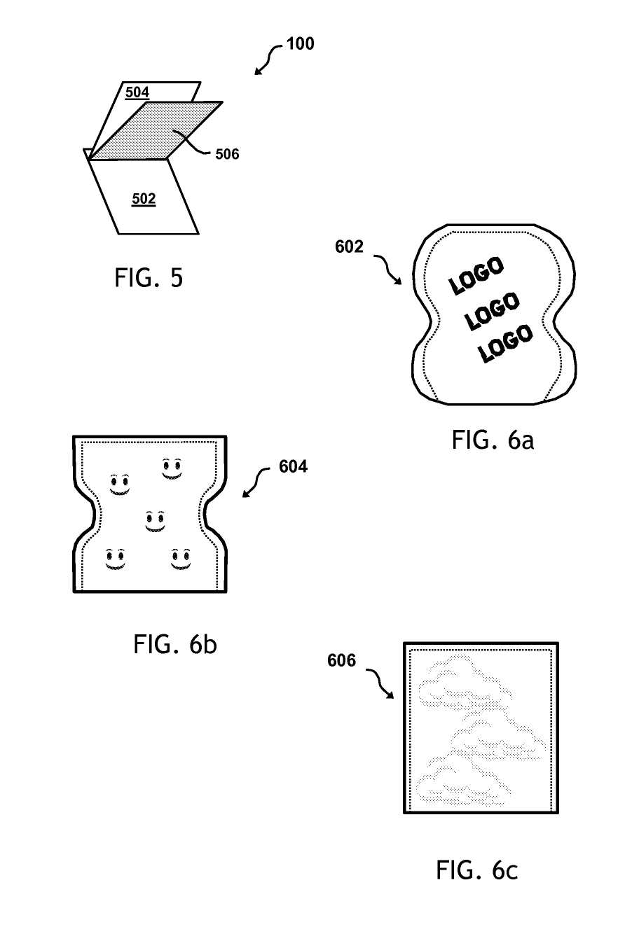

Referring now to FIGS. 5 and 6a-6c, various production and packaging considerations for the wipe product of the present invention are addressed. In FIG. 5, one simple embodiment for the production of the wipe product of the present invention depicts wipe 100 comprising a dry surface layer 502, separated from a wet surface layer 504 by a barrier layer 506 interposed therebetween. Layers 502, 504 and 506 may be provided in any natural or synthetic material or textile suit able for their in tended use, and may comprise either a single or multi-ply material. In some embodiments, for example, layer 506 may comprise a thin plastic film provided to keep a pre-moistened layer 504 from dampening a drying layer 502. Layers 502, 504 and 506 may be bound, bonded or joined together in any suitable fashion as described hereinabove.

In FIGS. 6a-6c, a variety of aesthetic finishes may be provided on wipe products according to the present invention. In FIGS. 6a and 6b, for example, wipe products 602 and 604 may be provided with a desired logo or character, respectively, or any other desired trademark, pattern or other visual decoration along one or more outer surfaces of the wipe. These markings may be applied after fabrication of the wipe, or may be fabricated into—or as part of—the layers that comprise the wipe. In FIG. 6c, wipe 606 is provided with a pattern partially embossed along one or more outer surfaces of the wipe. Similar embellishments, and various combinations thereof, are all comprehended by the present invention.

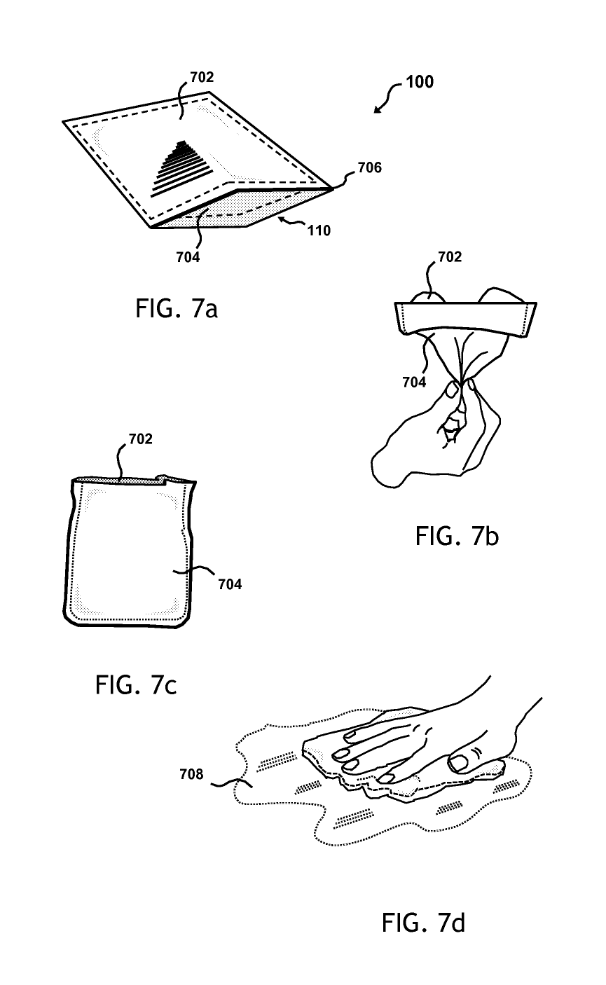

Another embodiment of a wipe product ac cording to the present invention is described now in reference to FIGS. 7a-7d. In FIG. 7a, wipe 100 is depicted with opening 110 in a substantially open position. In this embodiment, the entire outer surface 702 of wipe 100 comprises material suitable for moistening with a cleansing or conditioning solution or solvent (i.e., the wet surface). The solution or solvent may be applied to surface 702 during the manufacturing or packaging of wipe 100, or may be applied as desired by a consumer when ready for use. Wipe 100 further comprises a lining surface 704 specifically disposed within opening 110 to receive and/or cover a consumer's hand or fingers. As described in reference to other embodiments, surface 704 may be formed by simple selection of desired material layers, by spray-in or coating treatment, by insertion of a separate pouch or envelope, or by any other suitable process or means using any suitable material. In the embodiment depicted, surface 704 is formed in a manner, and comprises material, suitable for use as a drying surface—once wipe 100 is re versed, as depicted in FIGS. 7b & 7c. Wipe 100 may further comprise one or more intermediate layer(s), plies or barriers 706 between surfaces 702 and 704 that provide for physical separation of the surfaces, and that inhibit or impede the transfer of liquid or contaminant matter between the wet and drying surfaces. As previously described, layer 706 may comprise any suitable plastic, polymer, or other material that provides the desired separation in a reliable and economical manner.

Referring now to FIG. 7b, the process of reversing or inverting the interior and exterior portions of wipe 100 is depicted. As described in reference to previous embodiments, this process may be initiated by grasping or pinching an inner portion of wipe 100, opposite opening 110. As with other embodiments, this embodiment of wipe 100 may be provided with an inner pull portion to facilitate that grasping or pinching. A consumer pulls the interior portion of wipe 100 through opening 110. This process inverts the wipe and renders surface 704 as the exterior, and surface 702 as the interior, of wipe 100—as shown now in reference to FIG. 7c.

Depending upon the materials and intended end-use of wipe 100, a consumer may then use surface 704 to dry the area 708 already cleansed, using surface 702, as depicted in FIG. 7d. In alternative embodiments and uses, surface 704 may be used to dry other areas or the consumer's hands. In the embodiment depicted in FIG. 7d, the consumer simply holds or grips wipe 100 from the exterior to make use of surface 704. In other embodiments, the consumers may choose to insert their hand into the inverted wipe, via opening 110, in order to make use of surface 704.

As it should be apparent to those of skill in the art, a wide variety of variations in composition and use of wipe 100 are thus comprehended by the present invention. Wet and dry surfaces of the wipe may both be disposed along the exterior of a wipe product, while a portion of a user's hand is inserted into the interior of the wipe during use of both surfaces. Alternatively, a wet surface of the wipe may be disposed along the exterior of a wipe while a drying surface is disposed along the interior. A consumer initially places a portion of their hand within the wipe, where the drying surface is, to make use of the wet surface before inverting the wipe and using the drying surface. In other embodiments, the drying surface of the wipe may be initially disposed along the exterior of the wipe, while the wet surface is disposed along the interior of the wipe. In still other embodiments, both surfaces may be wet, but treated with different cleansing or conditioning solutions. In some alternative embodiments, all surfaces may be dry, or may be dry, and may or may not be pretreated with some form of powder or dry compound material. All such variations, and other similar variations and combinations thereof, are hereby comprehended.

Consider, for example, use in a medical or surgical setting where a wipe product may be used to clean up contaminants while maintaining a sterile environment for a user. A surgeon, nurse, or other medical professional, having already completed an extensive sterilization process, needs to clean up potentially contaminated blood or other bodily matter during a medical procedure. Preferably, the medical professional would be able to perform the clean up without needing to repeat the extensive sterilization process. A wipe product according to the present invention is provided such that its exterior is completely a drying surface, adapted to absorb and dry up the contaminated substance. The wipe is further provided such that its interior is a wet surface, treated with a sterilizing material such as alcohol. An appropriate barrier layer is provided between the exterior and interior of the wipe, such that no contamination may pass therebetween. The user may then place their sterile, gloved hand within the wipe, coming into contact with the sterilizing material while using the wipe to dry up the contaminated substance. The user may then invert the wipe, without having contact with now-contaminated drying surface. The wipe product may be safely disposed of or, if desired, the sterilizing material of the wet surface may be applied the area from which the contaminated substance was just removed.

This embodiment and a 11 other embodiments described herein are presented for purposes of illustration and explanation only. The specific compositions, configurations, orientations and operations of various features, portions and members may be provided in a number of ways, for application in a wide variety of end-uses, in accordance with the present invention. For example, all portions of a wipe product according to the present invention may be produced in bio-degradable material. In other embodiments, all portions of a wipe product according to the present invention may be produced in recycled post-consumer material. In another embodiment, wipe products may be packaged or provided in a roll, separated from each other by perforation. In still other embodiments, wipe products may be packaged separately, for individual use. In some embodiments, the wipe products may be for personal hygiene use, such as baby wipes and feminine cleansing wipes. In other embodiments, the wipe products may be for home or industrial use, such as medical sterilization wipes or kitchen/bath cleaning wipes. These and other similar variations in accordance with the present invention are thus comprehended hereby.

Thus, the embodiments and examples set forth herein are presented to best explain the present invention and its practical application and to thereby enable those skilled in the art to make and utilize the invention. As previously explained, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A wipe product comprising:
a plurality of layers;
a first surface of the plurality of layers adapted for moistening with a desired liquid;
a second surface of the plurality of layers adapted to dry a desired area; and
an opening in the plurality of layers, adapted to receive a portion of a user's hand.

2. The product of claim 1, wherein the opening is provided between the first and second surfaces.

3. The product of claim 1, wherein the first surface is pre-moistened with the desired liquid.

4. The product of claim 1, wherein the desired liquid is a cleansing liquid.

5. The product of claim 1, wherein the desired liquid is a conditioning liquid.

6. The product of claim 1, wherein the layers of the plurality of layers are coupled together having a seam.

7. The product of claim 1, wherein the wipe product further comprises a lining within the opening.

8. The product of claim 1, wherein the wipe product further comprises a margin portion disposed around the opening.

9. The product of claim 1, wherein the wipe product further comprises a closure feature.

10. The product of claim 9, wherein the closure feature is disposed in a margin portion disposed around the opening.

11. The product of claim 9, wherein the closure feature comprises a slidable strip of material.

12. The product of claim 9, wherein the closure feature comprises an adhesive material.

13. A hygienic wipe, comprising:
a first layer having a first surface, adapted for moistening with a desired liquid;
a second layer having a second surface, adapted to dry a desired area;
a third layer, interposed between the first and second layers, and adapted prevent the desired liquid from dampening the second surface; and
an opening formed in the wipe to receive a portion of a user's hand.

14. The wipe of claim 13, wherein the first surface is pre-moistened with the desired liquid.

15. The wipe of claim 13, wherein the wipe further comprises a margin portion disposed around the opening.

16. The wipe of claim 13, wherein the wipe further comprises a closure feature.

17. The wipe of claim 16, wherein the closure feature is disposed in a margin portion disposed around the opening.

18. The wipe of claim 16, wherein the closure feature comprises a slidable strip of material.

19. The wipe of claim 16, wherein the closure feature comprises an adhesive material.

20. The wipe of claim 16, wherein the closure feature comprises a hook-and-loop material.

21. A method of producing a cleansing wipe product, the method comprising the steps of:
providing a plurality of layers;
providing a first surface of the plurality of layers adapted for moistening with a desired liquid;
providing a second surface of the plurality of layers adapted to dry a desired area; and
forming an opening in the plurality of layers, adapted to receive a portion of a user's hand.

22. A method of producing a wipe product, the method comprising the steps of:
providing a plurality of layers;
providing a first surface of the plurality of layers adapted for moistening with a first desired liquid;
providing a second surface of the plurality of layers adapted for moistening with a second desired liquid; and
forming an opening in the plurality of layers, adapted to receive a portion of a user's hand.

23. A method of producing a wipe product, the method comprising the steps of:
providing a plurality of layers;
providing a first surface of the plurality of layers adapted for drying;
providing a second surface of the plurality of layers treated with a dry compound material; and
forming an opening in the plurality of layers, adapted to receive a portion of a user's hand.
